(19) United States
(12) Patent Application Publication
(10) Pub. No.: US 2025/0113962 A1
(43) Pub. Date: Apr. 10, 2025

(54) SYSTEM FOR COMPLETING WORK TASKS, HAVING AT LEAST ONE WORK DEVICE AND AT LEAST ONE DATA PROCESSING UNIT

(71) Applicant: Vorwerk & Co. Interholding GmbH, Wuppertal (DE)

(72) Inventors: Wenjie Yan, Düsseldorf (DE); Birol Ceylan, Dortmund (DE); Peter Wiedmann, Düsseldorf (DE); Peter Brüning, Mettmann (DE); Thomas Lessel, Velbert (DE); Peter Regier, Duisburg (DE); Denis Stogl, Karlsruhe (DE)

(21) Appl. No.: 18/816,105

(22) Filed: Aug. 27, 2024

(30) Foreign Application Priority Data
Sep. 8, 2023 (EP) 23196360.4

(51) Int. Cl. A47L 11/40; A47L 9/00; A47L 9/28; G05B 13/02; G05D 1/622; G05D 1/656; G05D 105/10; G06V 10/82; G06V 20/58

(52) U.S. Cl. CPC A47L 11/4011; A47L 9/009; A47L 9/2805; A47L 9/2852; A47L 11/4061; G05B 13/027; G05D 1/622; G05D 1/656; G06V 10/82; G06V 20/58; A47L 2201/04; G05D 2105/10

(57) ABSTRACT

A system having at least one working device and at least one data processing unit, wherein the working device has at least one sensor unit and is designed and configured for autonomous movement in an environment. The data processing unit includes at least one processor and at least one memory, wherein the data processing unit is designed and configured for determining spatial environment data with the sensor unit, for recognizing at least one object in the spatial environment data, for determining at least one object parameter of the object using at least part of the spatial environment data, and for selecting at least one action of the working device with respect to the object as a function of the at least one determined object parameter.

### CROSS REFERENCE TO RELATED APPLICATIONS

This application claims the benefit of priority under 35 U.S.C. § 119 to European Patent Application No.: 23196360.4, filed Sep. 8, 2023, the contents of which is incorporated herein by reference in its entirety.

### FIELD

The invention relates to a system for performing work tasks in an environment, a method and a computer program product. The system comprises at least one working device and at least one data processing unit.

### BACKGROUND

The statements in this section merely provide background information related to the present disclosure and several definitions for terms used in the present disclosure and may not constitute prior art.

Systems with working devices that move autonomously in an environment and perform work tasks, for example, are known from the state of the art. In particular, the working devices are autonomous vehicles or robots. During movement, collisions with objects in the environment must be reliably prevented. A frequently used approach for the detection of objects by work equipment is the use of camera and image processing systems. Modern working devices are often equipped with sophisticated cameras that provide visual information about their surroundings. Using this visual data, they can navigate efficiently and identify objects to prevent collisions.

At least one camera of the working device collects images of the surroundings at regular intervals, which are analyzed by a data processing unit. The data processing unit is usually designed and configured to recognize various objects and obstacles, for example by interpreting features such as shapes, colors and textures in image data.

In systems known from the state of the art, object recognition algorithms, in particular using neural networks, are often trained for object recognition by means of pixel-precise labeling of objects in reference images. This method is very time-consuming and cost-intensive due to the high effort required to create the training data. Furthermore, purely image-based systems can only provide information about the appearance of an object, meaning that optical effects in the image data can lead to the incorrect recognition of an object that actually has no or a different three-dimensional shape.

An objective of the present invention is therefore based on the task of providing a system, a method and a computer program product which ensures autonomous movement of a working device in an environment and which reliably ensures detection of objects during movement.

### SUMMARY

The aforementioned problem is solved by a system comprising at least one working device and at least one data processing unit and at least one memory. The working device has at least one sensor unit, in particular for collecting spatial environment data, and is designed and configured for autonomous movement in an environment, in particular a processing environment, and preferably for carrying out work tasks. Preferably, the data processing unit is designed and configured to control the autonomous movement and cleaning of the environment by the working or cleaning device. The data processing unit is designed and configured for determining spatial environment data with the sensor unit, for recognizing at least one object in the spatial environment data, for determining at least one object parameter of the object using at least part of the spatial environment data, and for selecting at least one action of the working device with respect to the object in dependency of the at least one determined object parameter.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 shows an example of a system,

FIG. 2 shows an example of a schematic sequence of the function of a system,

FIG. 3a shows an exemplary visualization of the step of capturing spatial environment data,

FIG. 3b shows an exemplary visualization of the step of recognizing an object in the spatial environment data,

FIG. 4a, 4b shows exemplary steps of recognizing an object in image data, and

FIG. 5 shows an example of a data processing unit.

The drawings are provided herewith for purely illustrative purposes and are not intended to limit the scope of the present invention.

### DETAILED DESCRIPTION

The following description is merely exemplary in nature and is in no way intended to limit the present disclosure or its application or uses. It should be understood that throughout the description, corresponding reference numerals indicate like or corresponding parts and features.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

In general, the present disclosure provides a system for performing work tasks in an environment, a method and a computer program product. The system comprises at least one working device and at least one data processing unit.

According to one aspect of the present disclosure, the working device is a cleaning device, a transportation device in transport logistics or a safety robot for environment monitoring. Preferably, the working device is a cleaning device for cleaning an environment, in particular a processing environment. The working device designed as a cleaning device is advantageously a cleaning device with a vacuum and/or mopping function, in particular a vacuum robot, a mopping robot or a vacuum and mopping robot. The working device has at least one housing, on which at least one drive unit and at least one cleaning tool are advantageously arranged. The drive unit preferably has at least two drive wheels.

The data processing unit has at least one processor and at least one, in particular non-volatile, memory. In particular, it is provided that at least part of the data processing unit is arranged in the working device. Preferably, the data processing unit is arranged completely in the working device. In this embodiment, therefore, all computing processes are performed by the working device itself.

If only a-first-part of the data processing unit is arranged in the working device, it is provided in particular that a further-second-part of the data processing unit is arranged at a distance from the working device and is connected or can be connected to it via a data connection. For example, the second part of the data processing unit is designed as a computer, in particular a server, arranged spatially in relation to the working device. The working device advantageously has at least one data interface in order to establish a data connection or to be connected to a data network. For example, the data interface is designed as a radio interface.

It is also provided, for example, that at least part of the data processing unit is connected or can be connected to the working device via a data connection, in particular a network, for example the Internet or a local network. The requests for computing operations are then transmitted to the data processing unit via the network and the result of the computing operations is transmitted from the data processing unit to the working device—via the data interface.

The data processing unit is designed and configured to determine spatial environment data using the sensor unit. The spatial environment data is, for example, three-dimensional information that represents the environment of the working device, in particular in the direction of travel. For example, the spatial environment data can be represented as a three-dimensional point cloud, in particular based on distance values. The spatial environment data is, for example, generated directly by collection, e.g. with a time-of-flight camera of the sensor unit, or calculated at least partially indirectly from detected environment data, e.g. from the detected data of a stereo camera. Determining the spatial environment data includes, in particular, directly capturing and/or calculating or generating spatial environment data from data collected by the sensor unit that at least partially represents the environment. The spatial environment data is preferably repeatedly redetermined or collected at regular intervals.

It is provided that the data processing unit controls the sensor unit for determining or collecting, or that the sensor unit carries out the determining or collecting itself. The detected and/or determined environment data are advantageously transmitted to the data processing unit or made available to it, e.g. in a memory. Preferably, the sensor unit has at least one camera, in particular an RGB camera, at least one time-of-flight sensor, in particular a time-of-flight camera, at least one stereo camera, at least one radar sensor, at least one ultrasonic sensor and/or at least one lidar sensor. The sensor unit is preferably arranged on the working device in such a way that it can detect at least part of the environment oriented in the direction of travel of the working device.

It is further advantageously provided that the sensor unit is designed and configured to determine the spatial environment data by means of depth estimation, in particular by means of triangulation and/or depth from focus or depth from movement. In particular, the sensor unit has at least or exactly one, at least or exactly two or at least or exactly three sensors. The sensor unit is advantageously designed and configured in such a way that spatial environment data can be detected or determined.

Triangulation is a method of depth estimation in which the spatial depth of a point in an image is calculated by using information from two or more viewing angles. Triangulation uses trigonometric principles to estimate the distance. Depth from focus is determined by varying the focus in image data. When the camera is focused on a point, it appears sharp, while objects at different distances become blurred. The blurring can be used to infer the depth. Depth-from-motion detection involves tracking the movement of objects between successive images, which allows the depth to be estimated.

Time-of-flight cameras are also known as PMD cameras. In particular, the camera is configured in such a way that it measures the time it takes for the light to reach the object and back again for each pixel. The runtime data therefore advantageously represents the distance of the object depicted in the image data from the camera or the working device for each pixel.

The data processing unit is also designed and configured to recognize at least one object—if present—in the spatial environment data. The recognition comprises in particular only the recognition of the presence of an object in the environment data. Preferably, the recognition of at least one object in the image data comprises filtering and/or segmenting at least some or all of the spatial environment data. For example, the spatial environment data can be represented as a point cloud, and filtering includes filtering out, i.e. removing, points that exceed a predetermined threshold value, for example in relation to their dimensions, e.g. their height and/or their width. Furthermore, filtering includes, for example, filtering out pixels belonging to the floor surface on which the cleaning device is moving. Furthermore, segmenting comprises, for example, applying the Euclidean cluster extraction method, in particular to cluster the pixels belonging to an object.

The data processing unit is also designed and configured to subsequently determine at least one object parameter of the object using at least part of the spatial environment data. Preferably, only the pixels in the spatial environment data that actually represent the object are used for the determination. For example, a geometric analysis of the object is carried out as part of the determination process and individual geometric properties of the object are derived as object parameters. The geometric properties can be direct or indirect. A direct property would be the width of the object, an indirect property the diameter of a circle or rectangle surrounding the object. For example, the object parameters are—indirect or direct—geometric characteristics of the object. Preferably, a set of object parameters with a plurality of object parameters is created for each object during the determination.

An object parameter is, for example, a length, a width or a height of the object. Furthermore, an object parameter is, for example, a length, a height and/or a width of a rectangle surrounding the object, also known as a “bounding box”. Furthermore, a surface texture, for example smooth, jagged or rough, is an object parameter. In addition, a direction or an angle of a surface normal, i.e. a perpendicular on a surface of the object, is also an object parameter. An object can advantageously be described or characterized by a plurality of object parameters—a set of object parameters.

In addition, the data processing unit is configured and designed to select at least one action of the working device in relation to the object as a function of the determined object parameter or a set of determined object parameters, in particular from a plurality of alternative actions. An action is, for example, a driving maneuver or a mode of action of the working device. Consequently, a selection is made depending on the object parameter or the determined object parameters, for example using a decision tree that represents the knowledge about the handling of an object on the basis of object parameters, which controls the further behavior of the working device, in particular with regard to locomotion.

For example, one selectable action is for the working device to change its direction of travel at least temporarily in order to drive around the object, i.e. to pass the object without touching it. Alternatively, the action that can be selected is to continue a planned travel path of the working device. The travel path is continued, for example, if no object or a very small and/or very flat object has been detected. In particular, it is intended that an object is driven over, especially while continuing a cleaning task of the working device. In particular, an object is always passed over if it is suitable for passing over. In particular, the object is evaluated as suitable for driving over using at least one object parameter.

The present disclosure has the advantage over the prior art that the determination of object parameters of the object—as geometry analysis—is generic, so that no specific target objects need to be defined and trained. Due to the simple analysis of the object and the description of the object based on three-dimensional information as object parameters, e.g. length, width, height, surface properties, normal direction and normal angle, no recognition and no classification of the specific object, in particular by a neural network, is required. This means that only the recognized geometry/topology can serve as the basis for decision-making. The invention ensures intelligent handling of obstacles, in particular objects, in an environment on the basis of a geometry analysis.

In one embodiment of the system, it has proven advantageous if it is provided that the data processing unit can also select the pushing of an object by the working device when selecting an action of the working device in addition to avoiding the object by at least temporarily changing the direction of travel of the working device and continuing a planned path of travel of the working device. The pushing is also selected using at least one, preferably a plurality of object parameters. The pushing of the object by the working device is preferably carried out until the object has reached a predefined position, for example on a wall or other boundary of the environment. In particular, it is also provided that the pushing takes place for a predefined period of time. After the predefined time period has elapsed, the spatial environment data is determined again, for example. This configuration has the advantage over the prior art that the environment can be tidied up by the working device by pushing objects to the side or to non-interfering positions in the environment. Pushing is only selected, for example, if the housing of the working device is technically suitable for pushing the respective object. For example, very small objects are only pushed if the working device has a sealing lip that can be used to push an object in the direction of travel. Pushing is advantageously selected taking into account the equipment of the working device, e.g. the presence of a sealing lip, a push bar or similar, and in particular its arrangement on the housing, e.g. the distance of a sealing lip from the floor.

According to a further embodiment of the system, it has been found to be advantageous if it is provided that the data processing unit is also designed and configured for capturing image data of the environment, for recognizing at least one object in the image data and for selecting an action using the result of the recognition.

Preferably, the image data is collected with the sensor unit. The image data is, for example, at least one RGB image or a grayscale image of at least part of the surroundings. The image data is preferably collected repeatedly at regular intervals. For example, the sensor unit is designed and configured to e or determine spatial environment data and image data. If the sensor unit has a time-of-flight camera, spatial environment information, e.g. a point cloud, and two-dimensional image information of the environment can be collected in an image data set. This means that both image data and spatial environment data are available from a scene. It is also provided that the sensor unit has, for example, a camera for capturing image data and an ultrasonic sensor.

The data processing unit is also designed and configured to recognize at least one object in the image data. Recognition takes place, for example, using an object recognition algorithm, which in particular comprises the use of a neural network. Preferably, the object is not only recognized in the image data, which determines the mere presence of an object, but an object is also identified by means of an object recognition algorithm. On the basis of the result of the detection or identification—as well as on the basis of the at least one object parameter—an action of the working device is then selected. If an object is recognized and/or identified in the image data, this fact is included as a result in the selection decision. If no object is detected, this result is also included in the selection decision, but leads to a different action of the working device. For example, the recognition in the image data and the recognition in the spatial environment data as well as the further steps are essentially carried out in parallel, so that the selection decision can be made using both results if necessary.

The object recognition algorithm preferably uses a neural network that has been trained to recognize objects in an environment, preferably with image data. For example, a rectangular frame is used as part of the recognition process. Such a rectangular frame is also referred to as a “bounding box”. In any case, the object recognition algorithm is designed and configured in such a way that it can recognize objects in image data and, in particular, mark them, preferably with a surrounding rectangle.

For example, the open source algorithm YOLO (You Only Look Once) version 7(as of July 2022) is used as the object recognition algorithm. YOLO is a powerful algorithm for object recognition in real time. It is characterized by its speed, high accuracy and versatility. Unlike other approaches, YOLO uses a single step for object recognition and advantageously draws bounding boxes around recognized objects. YOLO supports hardware acceleration for faster processing and can recognize multiple object classes in one image. It is also robust against different image sizes. Alternatively, the open source algorithm MobileNet version 3 (as of May 2019) can also be used as an object recognition algorithm.

This embodiment has the advantage that the selection of an action of the working device is based on independent methods for recognizing an object—processing the spatial environment data and processing the image data—which increases reliability. This also ensures that an working device can also process, for example clean, larger areas autonomously and without interaction with a user.

In order to be able to assign a position in space to the object, in particular also in the context of the recognition of an object in the image data, according to a further embodiment of the system it is provided that the data processing unit is configured and designed to assign distance information at least to the pixels of an object recognized, in particular an identified object, in the image data. After an object has been recognized in the image data, for example by an object recognition algorithm, the data processing unit assigns distance values or position values, which are known for example from the spatial environment data, to the pixels of the recognized object, in particular taking into account the respective perspective of the sensor unit. This allows the position of the object to be projected back into the three-dimensional space by assigning a corresponding value to the pixels.

In a preferred embodiment of the system, the result of the recognition in the spatial environment data—the object parameter(s)—and the result of the recognition in the image data are used together to select an action of the working device. A further embodiment of the system provides that the data processing unit is designed and configured to prioritize the result of the recognition in the spatial environment data over the result of the recognition in the image data, for example an object recognized, in particular identified, in the image data, when selecting the action of the working device. The geometry analysis based on the spatial environment data is preferably the primary method and image recognition is a secondary criterion. If, for example, the presence of an object was detected during image recognition, e.g. due to light influences or optical illusion, but at the same time no object was detected in the spatial environment data, the results of the image recognition are ignored and the action of continuing the cleaning process on the planned route, for example, is only selected on the basis of the result of the recognition.

This robustness and security of the system is improved according to a further embodiment in that it is provided that the data processing unit is designed and configured to select a push of a recognized object only if the object has been identified in the image data and has been found in a comparison with a release list held in a memory and/or has not been found in a blacklist.

This procedure ensures that the object is only pushed by the working device if the object is known and/or cannot be found in a blacklist containing objects that must not be pushed under any circumstances. The identification of the object ensures that the working device is mechanically capable of pushing an object.

The release list and/or the blacklist are predefined ex works, for example. However, it is also provided that the blacklist and/or the release list can be modified by the data processing unit and/or by data input by a user. For example, a user can add special objects that are in their household. In particular, the working device with the sensor unit can be used to visually perceive an object, scan it and then add it to the corresponding lists.

This configuration has the advantage that an object recognition algorithm only needs to be trained for a small number of objects, namely only for those objects that may be moved and/or may not be moved under any circumstances. The use of a release list is therefore particularly preferable.

In order to advantageously ensure that no objects are pushed by the working device that must not be pushed and/or run over that must not be run over, the data processing unit is designed and configured to select the avoidance of the object if an object cannot be identified in the image data. This ensures that only those objects are pushed by the working device that are approved for pushing behavior. Furthermore, only those objects will be run over that are suitable for this. If only detection takes place but identification is not possible, the temporary change of direction is always selected to avoid the object.

A further embodiment of the system provides that the data processing unit is designed and configured to calculate at least one selection value and/or at least one probability as to whether the working device can move an object recognized, in particular identified, in the image data by pushing it. For example, using the spatial environment data or an object recognized in the spatial environment data and its geometric properties, the data processing unit can determine a selection value or a probability. For example, the data processing unit performs a calculation using an assumed density of an object in order to estimate its weight. Furthermore, object parameters of the object are taken into account, for example, in order to calculate a selection value or a probability as to whether the object is geometrically suitable for being pushed by the working device.

The present disclosure also relates to a method for operating a system, in particular according to one of the described embodiments. The system has at least one working device and at least one data processing unit, wherein the working device has at least one sensor unit and is designed and configured for autonomous movement in an environment. The data processing unit has at least one processor and at least one memory. The method is characterized by at least the following method steps:
determining of spatial environment data with the sensor unit,
recognition of at least one object in the spatial environment data,
determining at least one object parameter of the object using at least part of the spatial environment data, and
selection of at least one action of the working device in relation to the object depending on the determined object parameter.

The method can be carried out, for example, by the data processing unit using the sensor unit and possibly other functions of the working device. The explanations on the function of the system can be transferred to the method, so that reference is made to the description of all embodiments of the system, which also further form the method.

The present disclosure further relates to a computer program product comprising commands which, when the program is executed by a data processing unit comprising at least one processor and at least one memory, cause the data processing unit to perform the steps of the described method.

Further advantageous embodiments of the present disclosure are shown in the following description of the figures.

In the various figures in the drawing, the same parts are always given the same reference numbers.

With regard to the following description, it is claimed that the present disclosure is not limited to the embodiments and thereby not limited to all or several features of described feature combinations, rather each individual partial feature of the/each embodiment is also of significance for the object of the present disclosure independently of all other partial features described in connection therewith, and also in combination with any features of another embodiment.

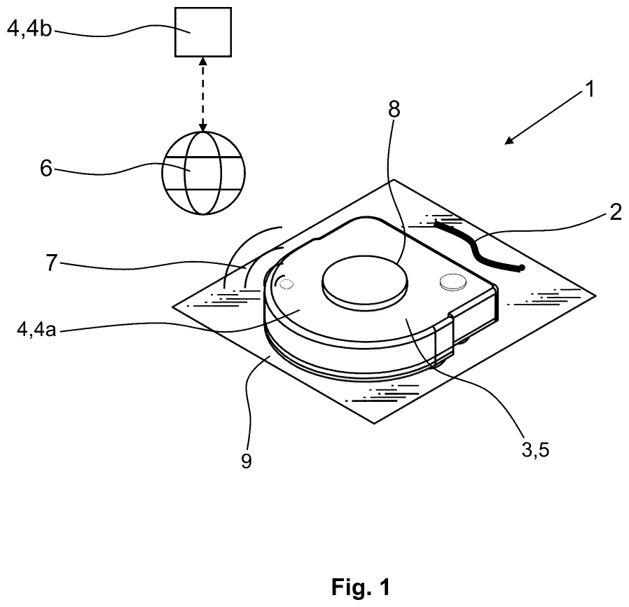

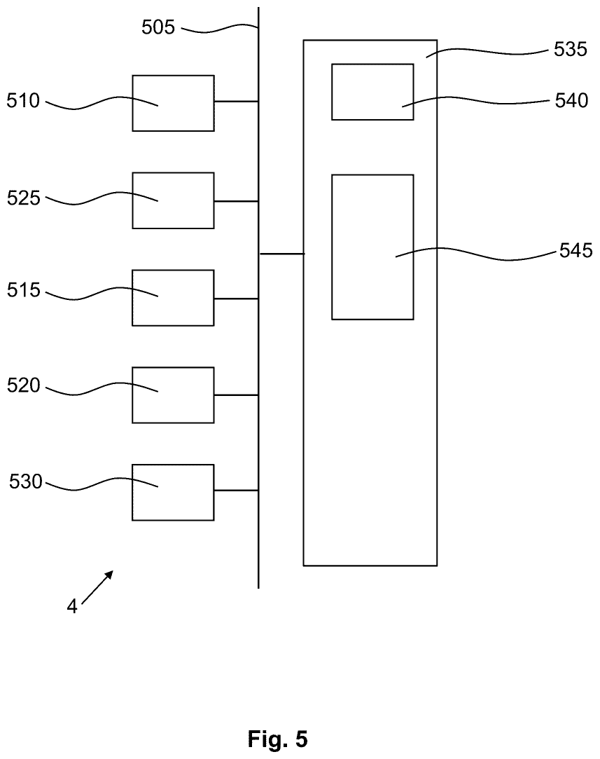

FIG. 1 schematically shows an embodiment of a system 1, in particular for carrying out work tasks. The system 1 has at least one working device 3 and at least one data processing unit 4. The system 1 is designed for the purpose of autonomous and collision-free movement of the working device 3 in an environment 9 for recognizing objects 2. In this embodiment example, the working device 3 is designed as a cleaning robot with which the environment can be cleaned. According to FIG. 1, the working device 3 has at least one sensor unit 8. A first part 4a of the data processing unit 4 is arranged inside a housing 5 of the working device 3. A second part 4b of the data processing unit 4 is designed as a computer, which is located at a distance from the working device 3 and is connected to the working device 3 via a data network 6, in this case the Internet. The working device 3 is connected-at least indirectly-to the data network 6 via a radio link 7. For further details of the design of the data processing unit 4, reference is made to FIG. 5, wherein the data processing unit 4 has at least one processor 510 and at least one memory 525. In particular, each part 4a, 4b of the data processing unit 4 has at least one processor 510 and at least one memory 525.

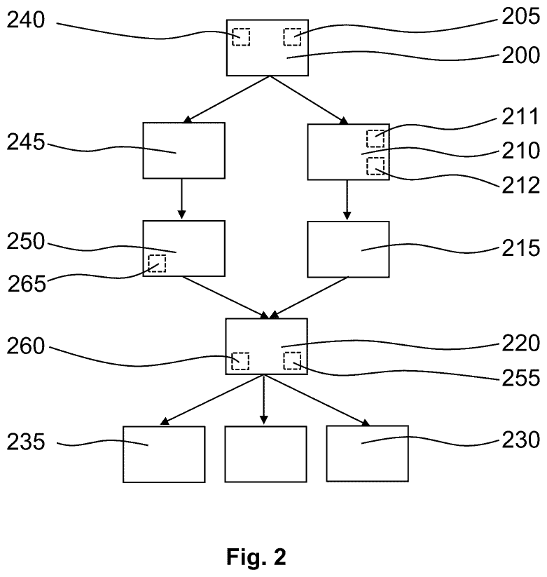

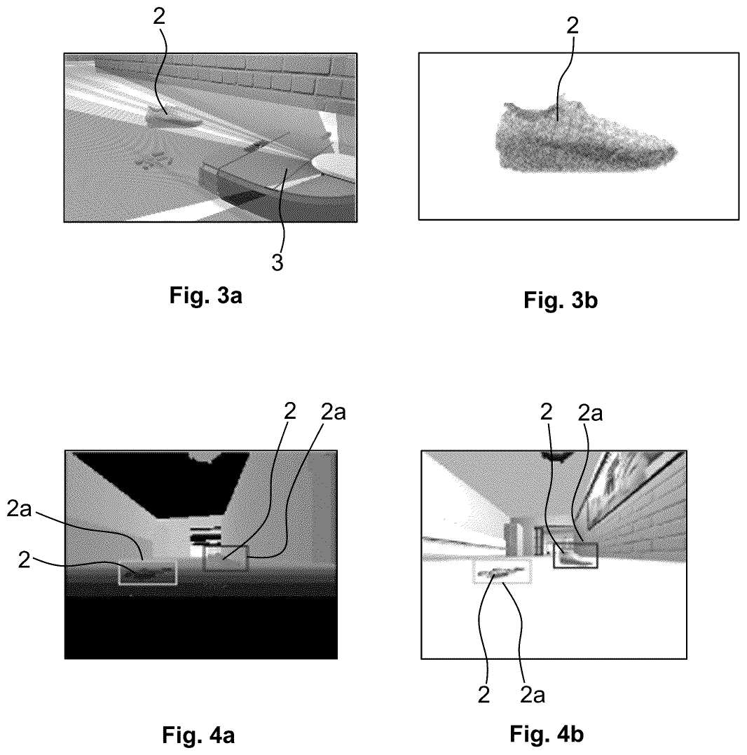

A schematic representation of the function of a system 1 is shown as an example in FIG. 2. The steps described are preferably initiated or executed by the data processing unit 4. The data processing unit 4 is designed to determine 205 spatial environment data with the sensor unit 8. In the present embodiment, the sensor unit 8 has at least one time-of-flight camera, so that the determination 205 of the spatial environment data takes place directly as part of the capturing 200 of an image data set comprising image data and spatial environment data. FIG. 3a shows an example of capturing 200 an image data set of an object 2 with the working device 3. The time-of-flight camera collects both the image data and the spatial environment data simultaneously and makes them available to the data processing unit 4. The spatial environment data can be determined from the runtime data of the time-of-flight camera and displayed, for example, as a point cloud. It is also provided that the spatial environment data is determined, e.g. calculated, by the data processing unit 4 using data from the sensor unit 8.

According to FIG. 2, the data processing unit 4 is also designed to recognize 210 at least one object 2 in the spatial environment data. Recognition 210 preferably comprises filtering 211 and segmenting 212 of the spatial environment data using the Euclidean cluster extraction method. FIG. 3b shows an example of a recognized object 2 in the spatial environment data, represented as a clustered three-dimensional point cloud.

If an object 2 has been recognized in the spatial environment data, the data processing unit 4 according to FIG. 2 is designed and configured to determine 215 a plurality of object parameters of the object 2 using at least part of the spatial environment data. Preferably, the part of the spatial environment data that represents the object 2 is selected. Object parameters are, for example, the height, width and length of a bounding box surrounding the object 2, the length, width and height of the object 2 itself, a surface texture or an angle or a direction of a surface normal of the object 2. The data processing unit 4 is also designed and configured to select at least one action of the working device 3 in relation to the object 2 as a function of at least one determined object parameter.

In particular, the data processing unit 4 is designed and configured to select 220 at least between avoiding 225 the object 2 by at least temporarily changing the direction of the working device 3, continuing 230 a planned path of travel of the working device 3 or pushing 235 the object 2.

As part of the described capturing 200 of an image data set by the sensor unit 8 with a time-of-flight camera, the collection 240 of the image data of the environment 9, i.e. the same scene that is also represented by the spatial environment data, also takes place. After the image data has been collected 240 by the data processing unit 4 with the sensor unit 8, at least one object is recognized 245 in the image data. Recognition 245 is preferably performed using an object recognition algorithm. FIG. 4a shows an example of the recognition 245 of two objects 2 that are marked with a rectangle 2a surrounding the object 2, a so-called “bounding box”. The object recognition algorithm preferably uses at least one neural network. If no object is recognized, this result is provided for the selection 220.

If an object 2 is recognized in the image data, it is particularly preferable for a recognized object 2 to also be identified 250 in the image data after recognition 245. FIG. 4b shows an example of the objects 2 now identified in the image data. In addition, distance information is assigned 265 to the pixels of an object 2 recognized and identified in the image data.

According to FIG. 2, the data processing unit 4 is subsequently designed and configured to select 220 an action of the working device 3 using the result of the identification 250 and the result of the recognition 215 in the spatial environment data, in this case the object parameters from the spatial environment data. In the selection 220 of the action of the working device 3, the determined object parameter(s) or the result of the recognition 215 are prioritized over an object 2 recognized in the image data.

The data processing unit 4 is designed and configured in such a way that selection 220 of pushing 235 only takes place if an identified object 2 has been found in a release list during a comparison 255, i.e. the type and properties of the object 2 have been clearly determined. This has the advantage that the neural network only needs to be trained for a small number of objects, namely exactly those objects that may be pushed.

The data processing unit 4 is furthermore designed and configured to calculate 260 a probability, as a further criterion for selection 220, before the selection of pushing 235, as to whether the working device 3 can move an object 2 recognized in the image data by pushing 235. If the selection value or the probability does not reach a predetermined threshold value, avoidance 225 is selected, for example.

FIG. 5 shows a simplified data processing unit 4 for a system 1 of the embodiments described. It is also provided that individual elements of the data processing unit 4 are present more than once, in particular if the data processing unit 4 is realized partly in a working device 3 and partly by a spatially remote computer. FIG. 5 shows a schematic representation of an embodiment of a data processing unit 4 which can carry out some or all of the steps of the methods described in the various embodiments or the steps thereof.

The data processing unit 4 is shown with hardware elements that are electrically coupled via a bus 505 or may otherwise communicate with each other. The hardware elements may include one or more processors 510, including without limitation one or more general purpose processors and/or one or more specialized processors, one or more input devices 515, and one or more output devices 520. The data processing unit 4 further comprises and/or is in communication with one or more memories 525.

The data processing unit 4 may further comprise a communication subsystem 530. In some embodiments, the data processing unit 4 further comprises a working memory 535. The data processing unit 4 may also include software elements located in the working memory 535, as exemplified. This may include an operating system 540, device drivers, executable libraries and/or another code, such as one or more application programs 545.

By way of example only, one or more steps described with respect to the functions of the system or method may be implemented as code and/or commands executable by a computer and/or a processor within a computer; in one aspect, such code and/or commands may then be used to configure and/or customize a general purpose computer or other device to perform one or more steps according to the described methods or functions of the system.

A portion of these commands and/or code may be stored on a, computer readable storage medium, such as the memory(s) 525 described above. As mentioned above, in one aspect, some embodiments may utilize a computer system such as the data processing unit 4 to perform procedures in accordance with various embodiments or the functions of the system 1. According to one embodiment, some or all of the steps of a procedure or functions of the system 1 are performed by the data processing unit 4 in response to execution by the processor 510 of one or more sequences of one or more commands that may be incorporated into the operating system 540 and/or other code, such as an application program 545, contained in the working memory 535. Such commands may be read into the working memory 535 from another computer readable medium, such as one or more of the memories 525. Merely by way of example, execution of the sequences of commands contained in the working memory 535 could cause the processor(s) 510 to perform one or more steps of the described procedures or functions of the system.

The terms “machine-readable medium” and “computer-readable medium”, as used herein, refer to any medium involved in providing data that causes a data processing unit to operate in a particular manner. In one embodiment implemented using the data processing unit 4, various computer-readable media may be involved in providing commands/code to the processor(s) 510 for execution and/or may be used to store and/or transmit such commands/code. In many implementations, a computer-readable medium is a physical and/or tangible storage medium. Such a medium may take the form of a non-volatile medium or a volatile medium. Examples of non-volatile media include optical and/or magnetic disks, such as memory 525. Examples of volatile media include dynamic memory, such as random access memory 535.

The communication subsystem 530 and/or its components typically receive signals, and the bus 505 may then transport the signals and/or the data, commands, etc. carried by the signals to the working memory 535 from which the processor(s) 510 retrieves and executes the commands. The commands received from the working memory 535 may optionally be stored in memory 525 before or after execution by the processor(s) 510.

The invention is not limited to the illustrated and described embodiments, but also includes all embodiments having the same effect in the sense of the invention. It is expressly emphasized that the embodiments are not limited to all features in combination, rather each individual subfeature can also have an inventive significance in its own right independently of all other subfeatures. Furthermore, the invention is not yet limited to the combination of features defined in any embodiment, but can also be defined by any other combination of certain features of all the individual features disclosed. This means that, in principle, practically any individual feature of any embodiment can be omitted or replaced by at least one individual feature disclosed elsewhere in the application.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A system, comprising at least one working device and at least one data processing unit, the working device having at least one sensor unit and being designed and configured for autonomous movement in an environment,
wherein the data processing unit comprises at least one processor and at least one memory,
wherein the data processing unit is designed and configured for determining spatial environment data with the sensor unit,
for recognizing at least one object in the spatial environment data,
for determining at least one object parameter of the object using at least part of the spatial environment data, and
for selecting at least one action of the working device with respect to the object in dependency of the at least one determined object parameter.

2. The system according to claim 1, wherein at least one part of the data processing unit is arranged in the working device.

3. The system according to claim 1, wherein the recognition of at least one object in the spatial environment data comprises at least one of filtering or segmenting.

4. The system according to claim 1, wherein the object parameter describes at least one of a length of the object, a width of the object, a height of the object, a length, a width of a rectangle surrounding the object, a height of the rectangle surrounding the object, a surface characteristic of the object, a direction of a surface normal of at least one surface of the object or an angle of a surface normal of at least one surface of the object.

5. The system according to claim 1, wherein the data processing unit is designed and configured for selecting at least one action at least between the action of avoiding the object by at least temporarily changing the direction of travel of the working device and the action of continuing a planned travel path of the working device.

6. The system according to claim 5, wherein the data processing unit, when selecting an action, is also designed and configured for selecting pushing of the object by the working device.

7. The system according to claim 1, wherein the data processing unit is furthermore designed and configured for collecting image data of the environment for recognizing at least one object in the image data and for selecting an action of the working device using the result of the recognition in the image data.

8. The system according to claim 7, wherein the recognition in the image data is carried out using at least one object recognition algorithm.

9. The system according to claim 7, wherein the data processing unit is designed and configured for assigning distance information at least to the pixels of an object recognized in the image data.

10. The system according to claim 7, wherein the data processing unit is designed and configured to prioritize the result of a recognition in the spatial environment data over a result of the recognition in the image data when selecting an action of the working device.

11. The system according to claim 7, wherein the data processing unit is designed and configured to select pushing of the object only if the object has been identified in the image data and at least has been found during a comparison with a release list held ready in a memory or at least has not been found in a blacklist.

12. The system according to claim 7, wherein the selection of the avoidance of the object always takes place if an object cannot be identified in the image data.

13. The system according to claim 7, wherein the data processing unit is designed and configured for calculating one or more of at least one selection value or at least one probability as to whether the working device can move an object recognized in the image data by pushing.

14. A method for operating a system comprising at least one working device and at least one data processing unit, wherein the working device has at least one sensor unit and is designed and configured for autonomous movement in an environment, wherein the data processing unit comprises at least one processor and at least one memory, the method comprising the following steps:
determining spatial environment data with the sensor unit,
recognizing at least one object in the spatial environment data,
determining at least one object parameter of the object using at least part of the spatial environment data, and
selection of at least one action of the working device with respect to the object in dependency of the determined object parameter.

15. A computer program product comprising commands which, when the program is executed by a data processing unit comprising at least one processor and at least one memory, cause the data processing unit to perform the steps of the method according to claim 14.

16. The system according to claim 1, wherein at least one part of the data processing unit is connectable to the working device via a data network.

17. The system according to claim 3, wherein the filtering comprises at least one of filtering pixels exceeding a predetermined threshold value, applying a Euclidean cluster extraction method, or filtering pixels belonging to the ground surface.

18. The system according to claim 7, wherein the data processing unit is designed and configured for collecting image data of the environment by the sensor unit for recognizing at least one object in the image data.

19. The system according to claim 7, wherein the data processing unit is further designed and configured for identifying at least one recognized object in the image data.

20. The system according to claim 8, wherein the object recognition algorithm uses at least one neural network.
